(19) United States
(12) Patent Application Publication
(10) Pub. No.: US 2006/0133507 A1
(43) Pub. Date: Jun. 22, 2006

(54) Picture information decoding method and picture information encoding method

(75) Inventors: Chong Soon Lim, Singapore (SG); Sheng Mei Shen, Singapore (SG); Shinya Kadono, Nishinomiya-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/293,181

(22) Filed: Dec. 5, 2005

Related U.S. Application Data
(60) Provisional application No. 60/632,969, filed on Dec. 6, 2004.

(51) Int. Cl. H04N 11/04; H04N 7/12; H04N 11/02; H04B 1/66

(52) U.S. Cl. 375/240.17; 375/240.25; 375/240.12; 375/240.16

(57) ABSTRACT

A picture information decoding method enables to switch a pixel precisions of a motion vector while compatibility with conventional standard is maintained and a delay occurred in parsing a picture parameter set is prevented, and it is judged whether or not a half_pixel_mv_flag indicating the pixel precision of the motion vector used for picture decoding is included as a last parameter in a plurality of parameters of a picture parameter set, and in the case where the half_pixel_mv_flag is included, the half_pixel_mv_flag is decoded.

### CROSS REFERENCE TO RELATED APPLICATION

This application claims the benefit of U.S. Provisional Application No. 60/632,969, filed Dec. 6, 2004, the contents of which are herein incorporated by reference in its entirety.

### BACKGROUND OF THE INVENTION

(1) Field of the Invention

The present invention relates to a picture information decoding method and a picture information encoding method for decoding and encoding picture information such as a picture parameter set.

(2) Description of the Related Art

Conventionally, a picture encoding apparatus encodes a moving picture so as to generate a bit stream which includes information of a plurality of pictures encoded per sequence. The bit stream has a sequence parameter set and a picture parameter set as a NAL unit.

It should be noted that the NAL unit concept, which is used for encoding a picture, is known in the standard like ITU-T H.264. In the NAL unit concept, header information related to a picture, a sequence (one sequence includes a plurality of pictures) and other high level information such as information not related to decoding of each picture, can be self-contained respectively in the NAL units. In fact such information can, therefore, be separated from the NAL unit, which is a slice obtained by encoding pixel value data of a picture. Such a concept enables to raise error resilience, since the NAL unit, which includes the particularly important header information in the bit stream, is encoded and transmitted repeatedly.

The sequence parameter set has a plurality of parameters related to encoding of the entire sequence. In other words the sequence parameter set has a plurality of parameters, which are commonly used for encoding and decoding a plurality of pictures in the sequence. On the other hand the picture parameter set has a plurality of parameters indicating encoding mode of the entire picture. In other words the picture parameter set has a plurality of parameters, which are used for decoding the respective encoded pictures.

Here Audio/Video Standards (AVS) 1.0 is available as a standard for a picture information decoding method and a picture information encoding method. According to AVS 1.0, a pixel precision of a motion vector is defined as quarter-pixel precision. In fact the sequence parameter set and the picture parameter set do not include information indicating the pixel precision of the motion vector. In the case where a picture decoding apparatus, which conforms to AVS 1.0, obtains a bit stream, the encoded motion vector included in the bit stream are always decoded as the motion vector of quarter-pixel precision irrespective of the descriptions of the sequence parameter set and the picture parameter set in the bit stream, so that motion compensation is performed using the encoded motion vector, and each picture in the bit stream is decoded based on the result of the motion compensation.

However in the case where the picture size is relatively small, quarter-pixel precision may not be required, since motion compensation with motion vector of half-pixel precision is able to realize a desirable compression ratio. In fact the bit number required for encoding the motion vector of quarter-pixel precision is greater than the bit number required for encoding the motion vector of half-pixel precision. Accordingly in the case where the picture size is relatively large, the motion vector of quarter-pixel precision is optimum, while in the case where the picture size is relatively small, the motion vector of half-pixel precision is optimum. In AVS 1.0, the pixel precision of the motion vector is defined as quarter-pixel precision, so that the optimum encoding processing and the optimum decoding processing may not be performed in the case where the motion vector of half-pixel precision is optimum.

In view of the aforesaid problem, an alteration of AVS 1.0 is currently examined as a proposed standard, so as to support half-pixel precision in addition to quarter-pixel precision.

FIG. 1 is a drawing showing a syntax of a sequence parameter set of the proposed standard.

In the sequence parameter set of the proposed standard, a half_pixel_mv_disable_flag, which does not exist in the sequence parameter set of AVS 1.0, is added.

In the case where the half_pixel_mv_disable_flag is 0, the flag indicates that the pixel precision of the motion vector can be switched between half-pixel precision and quarter-pixel precision. And in the case where the half_pixel_mv_disable_flag is 1, the flag indicates that the pixel precision of the motion vector cannot be half-pixel precision.

FIG. 2 is a drawing showing a syntax of a picture parameter set of the proposed standard.

In the picture parameter set of the proposed standard, in the case where a predefined condition is satisfied, the half_pixel_mv_flag, which does not exist in the picture parameter set of AVS 1.0, is newly added.

In fact, in the case where the half_pixel_mv_disable_flag in the sequence parameter set is 0 and the picture_coding_type is 1, the flag half_pixel_mv_flag is newly added in the picture parameter set. In the case where the half_pixel_mv_flag is 1, the flag indicates that the pixel precision of the encoded motion vector is half-pixel precision, while in the case where the half_pixel_mv_flag is 0, the flag indicates that the pixel precision of the encoded motion vector is quarter-pixel precision.

More specifically, in the case where the half_pixel_mv_flag is 1, the picture decoding apparatus performs decoding of the motion vector and performs motion compensation using the motion vector in the bit stream as half-pixel precision. And in the case where the half_pixel_mv_flag is 0, the picture decoding apparatus performs decoding of the motion vector and performs motion compensation using the motion vector in the bit stream as quarter-pixel precision.

As described above, according to the proposed standard, the pixel precision of the motion vector can be switched between quarter-pixel precision and half-pixel precision.

However the sequence parameter set and the picture parameter set of the proposed standard are interdependent. Thus there exist problems that the decoding of the bit stream is impossible, or the decoding processing of the bit stream might be delayed due to the complexity of the syntaxes of these parameter sets.

In fact, as described above, in the case where the half_pixel_mv_disable_flag in the sequence parameter set is 0 and the picture_coding_type is 1, the half_pixel_mv_flag is set up in the picture parameter set. Accordingly the sequence parameter set and the picture parameter set are interdependent. Due to the fact, even if the picture decoding apparatus obtains the picture parameter set, which is transmitted before the sequence parameter set in the stream, earlier than the sequence parameter set, it is not possible to judge whether or not the half_pixel_mv_flag is set up in the picture parameter set without the sequence parameter set. As a result, the picture decoding apparatus is not able to perform parsing the picture parameter set and not able to perform optimum decoding of the bit stream until the picture decoding apparatus obtains the sequence parameter set, so that the decoding processing is delayed.

Furthermore the sequence parameter set and the picture parameter set of the proposed standard, and the sequence parameter set of AVS 1.0 have no compatibility, so that the picture decoding apparatus conforming to the proposed standard has a problem that the parameter sets of AVS 1.0 are not performed parsing and decoding.

More specifically the picture decoding apparatus conforming to the proposed standard performs parsing of the sequence parameter set supposing that the half_pixel_mv_disable_flag is included in the sequence parameter set, so that parsing of the sequence parameter set of AVS 1.0, which does not includes the half_pixel_mv_disable_flag, is not performed properly.

### SUMMARY OF THE INVENTION

In view of aforesaid problems, the object of the present invention is to provide a picture information decoding method and a picture information encoding method that enable to switch pixel precisions of motion vector while the compatibility with the conventional AVS 1.0 is maintained, and a delay occurred in parsing the picture parameter set is prevented.

In order to achieve the aforesaid object, the picture information decoding method of the present invention decodes a picture parameter set which includes a plurality of parameters used for decoding a picture, the method includes: judging whether or not precision information, which indicates a pixel precision of a motion vector used for decoding the picture, is included as a last parameter among a plurality of parameters in the picture parameter set; and decoding the precision information in the case where it is judged that the precision information is included as the last parameter in the picture parameter set. For example the precision information includes a flag which indicates 0 or 1. In the case where the flag indicates 0, the precision information indicates quarter-pixel precision, while in the case where the flag indicates 1, the precision information indicates half-pixel precision.

Accordingly it can be judged that the precision information is included as the last parameter of the picture parameter set, so that the other parameters in the picture parameter set are sequentially decoded from the front properly, and the encoded pictures in the bit stream can be decoded properly using each parameter, even in the case where the precision information is not included in the picture parameter set like the picture parameter set of AVS 1.0. Further even in the case where the precision information is included on the last line as a parameter of the picture parameter set, the respective parameters including the precision information of the picture parameter set are decoded sequentially from the front properly, and then the data (the precision information of the motion vector) which is not included in AVS 1.0 are decoded at the end of the picture parameter set. Thus, the description of the precision information of the motion vector, which was encoded and included in the bit stream, for example half-pixel precision motion vector and quarter-pixel precision motion vector can be switched suitably. Further the existence of the precision information included in the picture parameter set can be judged easily irrespective of the description of the sequence parameter set, so that the delay occurred in parsing picture parameter set can be prevented.

In addition the picture information decoding method further may include performing motion compensation using the motion vector with the pixel precision indicated in the decoded precision information, in the case where the precision information is included in the picture parameter set, and may include performing motion compensation using the motion vector with a predetermined pixel precision, in the case where the precision information is not included in the picture parameter set.

Accordingly in the case where the precision information is included in the picture parameter set, the motion vector, which was encoded and is included in the bit stream, is decoded suitably based on the description of the precision information for example half-pixel precision motion vector and quarter-pixel precision information, and the motion compensation is performed with the pixel precision. In the case where the precision information is not included in the picture parameter set, the motion vector which was encoded and included in the bit stream is properly decoded as the motion vector with a predetermined pixel precision, and then the motion compensation is performed with the pixel precision. As a result even in the case where the precision information is not included in the picture parameter set like the picture parameter set of AVS 1.0, the picture in the bit stream can be properly decoded based on the picture parameter set.

The picture information decoding method may include: in judging whether or not the precision information is included, decoding sequentially prepositional parameters which is included in a plurality of parameters excluding the precision information; judging that the precision information is not included in the case where a specific bit string, which is placed at the end of the picture parameter set, is detected immediately after the prepositional parameter which has been decoded lastly; and judging that the precision information is included in the case where the specific bit string is not detected immediately after the prepositional parameter which has been decoded lastly.

Accordingly the existence of the precision information is judged based on the result of the detection of the specific bit string consisting of the combination of “1” and “0” like rbsp_trailing_bits, so that the existence of the precision information can be judged properly.

It should be noted that the present invention can be implemented, not only with the aforesaid picture information decoding method, but also with the picture information encoding method, and also can be implemented by the picture information decoding apparatus and the picture information encoding apparatus which decodes and encodes the picture based on the aforesaid methods, as the data structure of the picture parameter set based on the aforesaid methods, as program directing computer to execute the operations by the methods, and as the storage medium which stores the program.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a drawing showing a syntax of a sequence parameter set of a proposed standard for the conventional standard;

FIG. 2 is a drawing showing a syntax of a picture parameter set of the proposed standard for the conventional standard;

FIG. 3 is a drawing showing a syntax of a sequence parameter set of an embodiment of the present invention;

FIG. 4 is a drawing showing a syntax of a picture parameter set of the embodiment of the present invention;

FIG. 5 is a block diagram showing a configuration of a picture decoding apparatus of the embodiment of the present invention;

FIG. 6 is a flowchart showing decoding process for the picture parameter set performed by a variable length decoding unit of the embodiment of the present invention;

FIG. 7 is a block diagram showing a configuration of a picture encoding apparatus of the embodiment of the present invention;

FIG. 8 is a flowchart showing encoding process for the picture parameter set performed by a variable length encoding unit of the embodiment of the present invention;

FIG. 9A is a drawing showing a syntax of a conventional picture header;

FIG. 9B is a drawing showing a syntax of a picture header including a repeated_header_cnt of the present invention;

FIG. 10 is a flowchart showing decoding process for the picture header performed by the picture decoding apparatus of the present invention; and

FIG. 11 is a flowchart showing encoding process for the picture header performed by the picture encoding apparatus of the present invention.

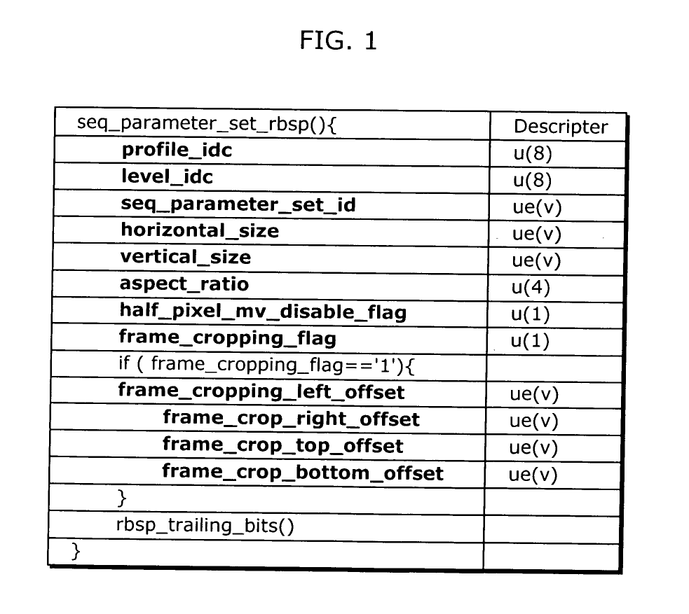

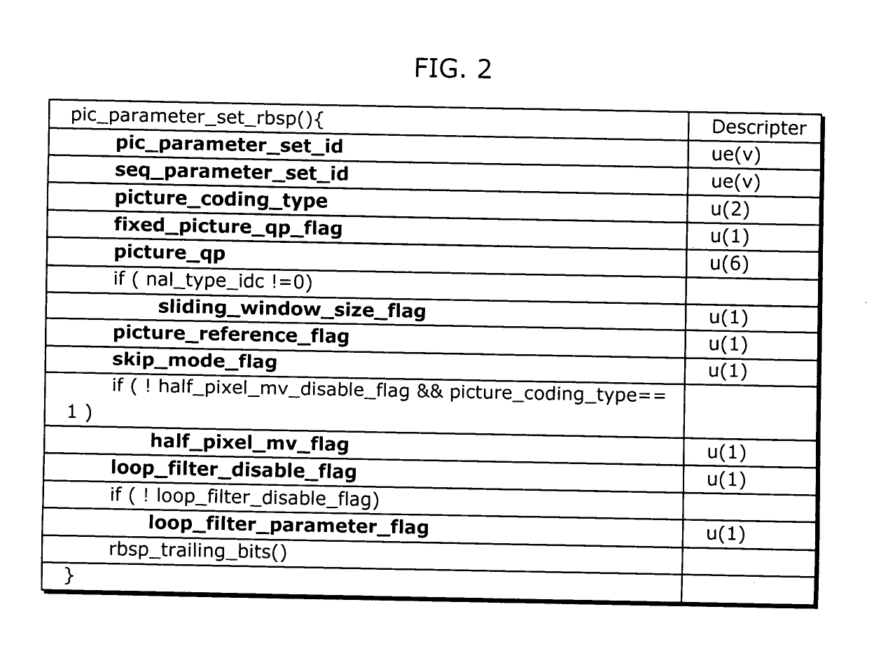

### DESCRIPTION OF THE PREFERRED EMBODIMENT

Hereafter a picture information decoding method and a picture information encoding method for the embodiment of the present invention will be described referring to the drawings.

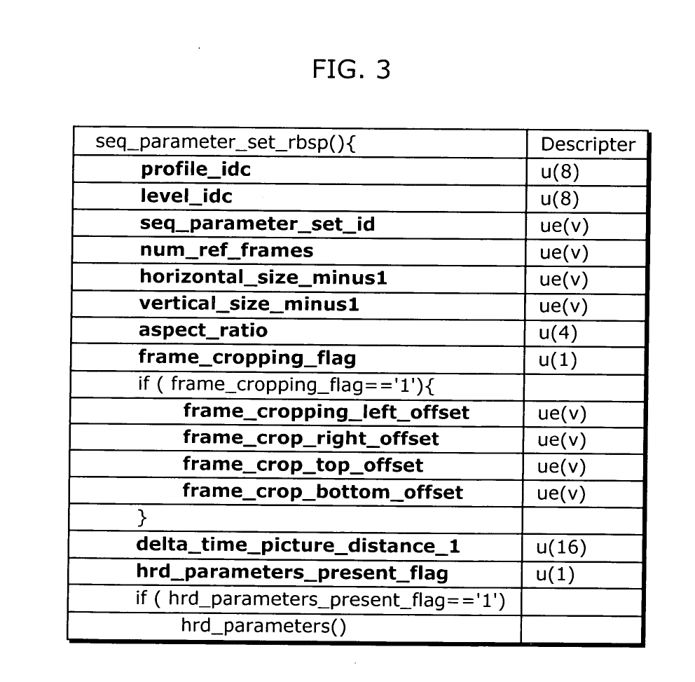

FIG. 3 is a drawing showing a syntax of a sequence parameter set of the present embodiment.

The sequence parameter set of the present embodiment does not include a half_pixel_mv_disable_flag. The sequence parameter set includes a plurality of parameters such as a profile_idc and a level_idc which are included in the conventional AVS 1.0. For example the profile_idc is a flag of 8 bits indicating a profile to which a bit stream including the sequence parameter set conforms.

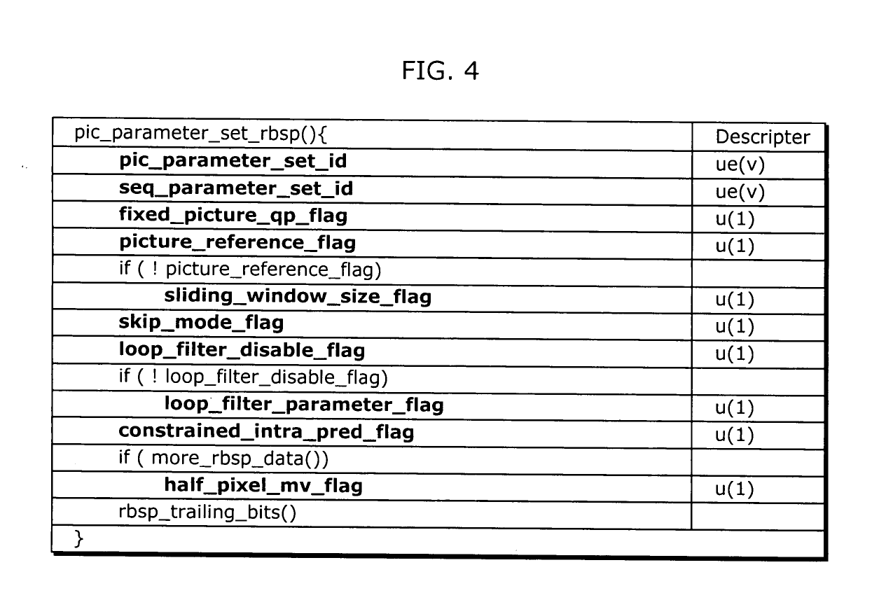

FIG. 4 is a drawing showing a syntax of a picture parameter set of the present embodiment.

The picture parameter set of the present embodiment includes a plurality of parameters used for decoding the encoded pictures in the bit stream. For example the picture parameter set includes a plurality of parameters such as a pic_parameter_set_id and a seq_parameter_set_id sequentially from the front of the picture parameter set. The pic_parameter_set_id is a parameter to represent a value for identifying the particular picture parameter set, while the seq_parameter_set_id is a parameter to represent a value for searching for a particular sequence parameter set used for the encoded picture. The parameters other than the half_pixel_mv_flag are the same as the parameters in the syntax of the conventional AVS 1.0.

Here in the picture parameter set of the present embodiment, the half_pixel_mv_flag of for example 1 bit, which indicates the pixel precision of an encoded motion vector in the bit stream, is set up on the last line of the picture parameter set when needed. In the case where the half_pixel_mv_flag is 1, the flag indicates that the pixel precision of the motion vector is half-pixel precision. And in the case where the half_pixel_mv_flag is 0, the flag indicates that the pixel precision of the motion vector is quarter-pixel precision. Accordingly the half_pixel_mv_flag of the present embodiment represents the precision information indicating the pixel precision of the motion vector.

More specifically, the half_pixel_mv_flag is located immediately after a constrained_intra_pred_flag and immediately before an rbsp_trailing_bits. The rbsp_trailing_bits is a bit string of a specific variable length code, and the bit string has a pattern that it starts from 1 of 1 bit and the bit string of an arbitrary number of 0 continue until the start position of the subsequent byte string (with a unit of multiples of 8 in a bit string). Such rbsp_trailing_bits is added as the last bit string of each NAL, so as to make the length of the picture parameter set multiples of 8 bits.

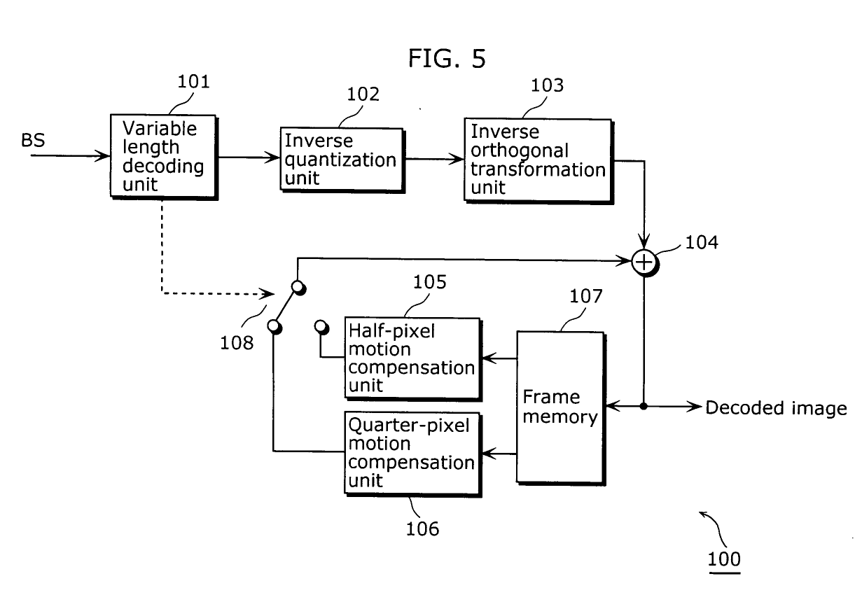

FIG. 5 is a block diagram showing a configuration of the picture decoding apparatus of the present embodiment.

The picture decoding apparatus 100 of the present embodiment includes a variable length decoding unit 101, an inverse quantization unit 102, an inverse orthogonal transformation unit 103, an adder 104, a frame memory 107, a half-pixel motion compensation unit 105, a quarter-pixel motion compensation unit 106 and a switch 108.

The variable length decoding unit 101 obtains a bit stream BS including the aforesaid sequence parameter set and the picture parameter set. And then the variable length decoding unit 101 performs variable length decoding to the sequence parameter set and the picture parameter set included in the bit stream BS. At the time of the decoding, in the case where the half_pixel_mv_flag is not included in the picture parameter set, the variable length decoding unit 101 sets the half_pixel_mv_flag to 0. Further, the variable length decoding unit 101 performs the variable length decoding to the encoded pictures, so as to generate a quantization value, and then the quantization value is outputted to the inverse quantization unit 102.

The inverse quantization unit 102 inversely quantizes the quantization value outputted from the variable length decoding unit 101, so as to generate a frequency coefficient, and then the frequency coefficient is outputted to the inverse orthogonal transformation unit 103.

The inverse orthogonal transformation unit 103 performs inverse orthogonal transformation such as inverse Discrete Cosine Transform (DCT) using the frequency coefficient outputted from the inverse quantization unit 102, so as to generate an image of a difference, and then the image of the difference is outputted to the adder 104.

The adder 104 adds the image of the difference outputted from the inverse orthogonal transformation unit 103 to a prediction image outputted through the switch 108, so as to generate a decoded image.

The frame memory 107 stores the decoded image generated by the adder 104.

The half pixel motion compensation unit 105, based on the decoded image stored in the frame memory 107, performs motion compensation using the motion vector of half-pixel precision so as to generate and output a prediction image of half-pixel precision.

The quarter-pixel motion compensation unit 106, based on the decoded image stored in the frame memory 107, performs motion compensation using the motion vector of quarter-pixel precision so as to generate and output a prediction image of quarter-pixel precision.

The switch 108, based on the value of the half_pixel_mv_flag (0 or 1) decoded by the variable length decoding unit 101, and the value of the half_pixel_mv_flag (0 as the value in the case of the not-encoded half_pixel_mv_flag in the picture parameter set), switches between outputting the prediction image of half-pixel precision to the adder 104, and outputting the prediction image of quarter-pixel precision to the adder 104. In fact, the switch 108 outputs the prediction image of quarter-pixel precision to the adder 104 in the case where the half_pixel_mv_flag is 0, and outputs the prediction image of half-pixel precision to the adder 104 in the case where the half_pixel_mv_flag is 1.

Accordingly the picture decoding apparatus 100 of the present embodiment performs decoding the encoded motion vector included in the bit stream as the motion vector of quarter-pixel precision in the case where the half_pixel_mv_flag is 0, and then performs motion compensation using the motion vector. On the other hand, the picture decoding apparatus 100 performs decoding the encoded motion vector included in the bit stream as the motion vector of half-pixel precision in the case where the half_pixel_mv_flag is 1, and performs motion compensation using the motion vector.

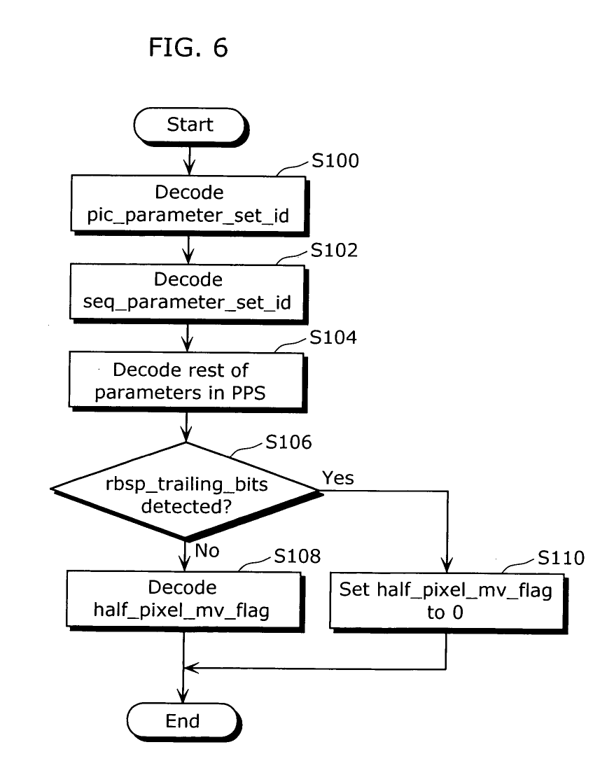

FIG. 6 is a flowchart showing decoding process for the picture parameter set performed by the variable length decoding unit 101 in the picture decoding apparatus 100.

First the variable length decoding unit 101 decodes the pic_parameter_set_id in the picture parameter set (step S100). Next the variable length decoding unit 101 decodes the seq_parameter_set_id in the picture parameter set (step S102). Further the variable length decoding unit 101 decodes the rest of the parameters in the picture parameter set (PPS) (step S104). In fact, the variable length decoding unit 101 decodes, from the first line sequentially, the prepositional parameters in a plurality of parameters in the picture parameter set other than the half_pixel_mv_flag in the step S100 to step S104.

Here the variable length decoding unit 101 judges whether or not the rbsp_trailing_bits is detected (step S106). In fact, the variable length decoding unit 101 judges whether or not the undecoded half_pixel_mv_flag still exists in the picture parameter set.

More specifically the variable length decoding unit 101, from immediately before the next byte aligned position, finds the bit “1” starting from the lowest significant bit position to the most significant bit position in the picture parameter set, so as to detect the rbsp_trailing_bits. And in the case where the bit “1” position is the bit position immediately after the decoded prepositional parameter on the last line (for example the constrained_intra_pred_flag), the variable length decoding unit 101 detects the rbsp_trailing_bits immediately after the prepositional parameter which has been decoded lastly, and then the variable length decoding unit 101 judges that the half_pixel_mv_flag is not included in the picture parameter set. On the other hand in the case where the bit “1” position is the bit position not immediately after the decoded prepositional parameter on the last line (for example the constrained_intra_pred_flag), the variable length decoding unit 101 does not detect the rbsp_trailing_bits immediately after the prepositional parameter which has been decoded lastly, and then the variable length decoding unit 101 judges that the half_pixel_mv_flag is included in the picture parameter set.

In the case where the variable length decoding unit 101 does not detect the rbsp_trailing_bits (No in step 5106), since the picture parameter set includes the half_pixel_mv_flag, the variable length decoding unit 101 decodes the half_pixel_mv_flag (0 or 1) (step S108). On the other hand in the case where the variable length decoding unit 101 detects the rbsp_trailing_bits (Yes in step S106), since the half_pixel_mv_flag is not included in the picture parameter set, the variable length decoding unit 101 sets the half_pixel_mv_flag to 0 (step S110).

Thus the variable length decoding unit 101 of the present embodiment is configured as a picture information decoding apparatus which includes: a judging unit to judge whether or not the half_pixel_mv_flag, which indicates the pixel precision of the motion vector used for decoding the picture, is included as the last parameter among a plurality of parameters in the picture parameter set; and a decoding unit to decode the half_pixel_mv_flag in the case where the half_pixel_mv_flag is included in the picture parameter set.

Accordingly in the present embodiment, it is judged whether or not the half_pixel_mv_flag is included as a parameter on the last line in the picture parameter set, so that, even in the case where the half_pixel_mv_flag is not included in the picture parameter set like AVS 1.0, the other parameters in the picture parameter set are properly decoded sequentially from the first line, and the encoded pictures in the bit stream are properly decoded using each parameter. Additionally even in the case where the half_pixel_mv_flag is included as a parameter on the last line in the picture parameter set, the half_pixel_mv_flag is decoded, so that the respective parameters including the half_pixel_mv_flag in the picture parameter set are properly decoded sequentially from the first line, and the encoded pictures in the bit stream are properly decoded using the respective parameters including the half_pixel_mv_flag. Thus the compatibility with the conventional AVS 1.0 can be maintained. Furthermore in the case where the half_pixel_mv_flag is included in the picture parameter set, the half_pixel_mv_flag is decoded, so that it is possible to switch the description of the half_pixel_mv_flag, for example the motion vector of half-pixel precision or quarter-pixel precision, for the encoded motion vector included in the bit stream. Further it is judged whether or not the half_pixel_mv_flag is included as the last parameter among a plurality of parameters in the picture parameter set, so that it is easily judged whether or not the half_pixel_mv_flag exists irrespective of the description of the sequence parameter set. The fact enables to prevent the delay occurred in parsing picture parameter set.

It should be noted that in the embodiment of FIG. 6, it is assumed that, the bit “1” is found from immediately before the start of the next byte aligned position to the most significant bit position. Alternatively the bit “1” may be found starting from the last bit position to the most significant bit position sequentially in the picture parameter set.

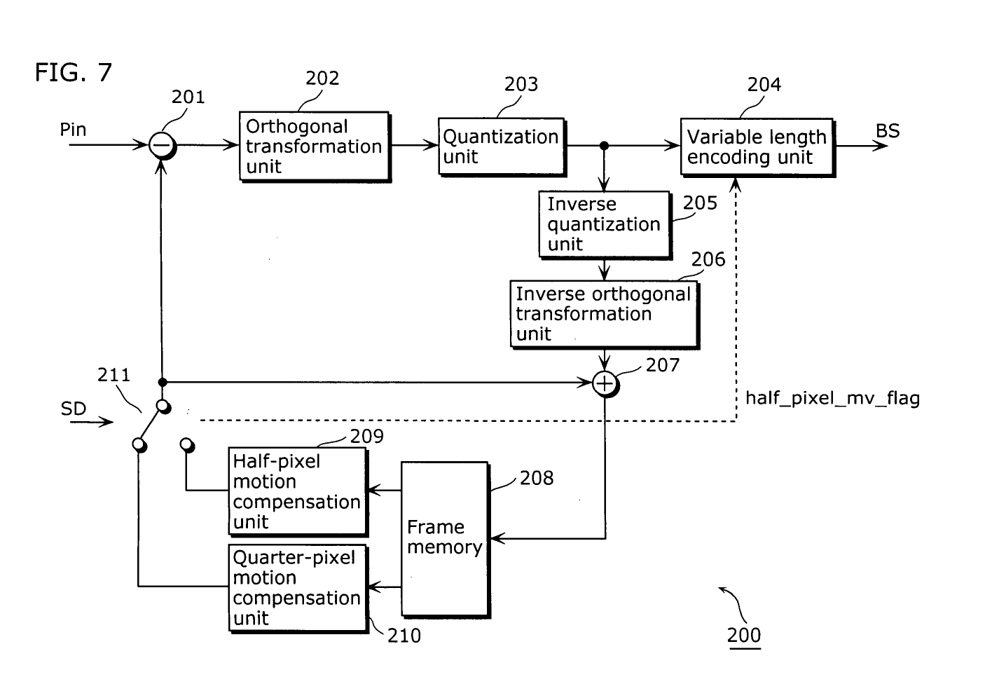

FIG. 7 is a block diagram showing a configuration of a picture encoding apparatus of the present embodiment.

The picture encoding apparatus 200 of the present embodiment includes a subtracter 201, an orthogonal transformation unit 202, a quantization unit 203, a variable length encoding unit 204, an inverse quantization unit 205, an inverse orthogonal transformation unit 206, an adder 207, a frame memory 208, a half-pixel motion compensation unit 209, a quarter-pixel motion compensation unit 210 and a switch 211.

The subtracter 201 obtains the prediction image through the switch 211, and subtracts the prediction image from the inputted image Pin, so as to generate an image of a difference. And then the subtracter 201 outputs the image of the difference to the orthogonal transformation unit 202.

The orthogonal transformation unit 202 performs orthogonal transformation such as Discrete Cosine Transform (DCT) to the image of the difference outputted from the subtracter 201, so as to generate a frequency coefficient, and then the frequency coefficient is outputted to the quantization unit 203.

The quantization unit 203 quantizes the frequency coefficient outputted from the orthogonal transformation unit 202, so as to generate and output a quantization value.

The inverse quantization unit 205 inversely quantizes the quantization value outputted from the quantization unit 203, so as to generate a frequency coefficient, and then the frequency coefficient is outputted to the inverse orthogonal transformation unit 206.

The inverse orthogonal transformation unit 206 performs inverse orthogonal transformation such as inverse DCT to the frequency coefficient outputted from the inverse quantization unit 205, so as to generate an image of a difference, and the image of the difference is outputted to the adder 207.

The adder 207 adds the prediction image outputted through the switch 211 to the image of the difference outputted from the inverse orthogonal transformation 206, so as to generate a decoded image.

The frame memory 208 stores the generated decoded image generated by the adder 207

The half pixel motion compensation unit 209, based on the decoded image stored in the frame memory 208, performs motion compensation using the motion vector of half-pixel precision so as to generate and output a prediction image of half-pixel precision.

The quarter pixel motion compensation unit 210, based on the decoded image stored in the frame memory 208, performs motion compensation using the motion vector of quarter-pixel precision so as to generate and output a prediction image of quarter-pixel precision.

The switch 211, based on the signal SD from outside, switches between outputting the prediction image of half-pixel precision to the adder 207, and outputting the prediction image of quarter-pixel precision to the adder 207. In fact in the case where the switch 211 switches the pixel precision of the prediction image to half-pixel precision, the switch 211 outputs the half_pixel_mv_flag indicating value 1 to the variable length encoding unit 204. In the case where the switch 211 switches the pixel precision of the prediction image to quarter-pixel precision, the switch 211 outputs the half_pixel_mv_flag indicating value 0 to the variable length encoding unit 204. As the examples of the signal SD, in the case where the picture size is relatively small, half-pixel precision is selected, and in the case where the picture size is relatively large, quarter-pixel precision is selected.

The variable length encoding unit 204 performs variable length encoding to the quantization value outputted from the quantization unit 203, the motion vector used for motion compensation in the half-pixel motion compensation unit 209 and quarter-pixel motion compensation unit 210 and the like, so as to generate a bit stream BS. Additionally the variable length encoding unit 204 encodes sequentially a plurality of parameters to be encoded included in the sequence parameter set and the picture parameter set, and then puts the encoded sequence parameter set and the encoded picture parameter set in the bit stream BS.

Here in the case where the half_pixel_mv_flag outputted from the switch 211 is 1, the variable length encoding unit 204 of the present embodiment encodes the half_pixel_mv_flag. And then the variable length encoding unit 204 places the encoded half_pixel_mv_flag on the last line of a plurality of encoded parameters in the picture parameter set. In fact, the variable length encoding unit 204 encodes sequentially the prepositional parameters in the picture parameters other than the half_pixel_mv_flag, and then places the encoded half_pixel_mv_flag immediately after the prepositional parameter which has been encoded lastly, for example the constrained_intra_pred_flag. Further the variable length encoding unit 204 places the rbsp_trailing_bits immediately after the encoded half_pixel_mv_flag.

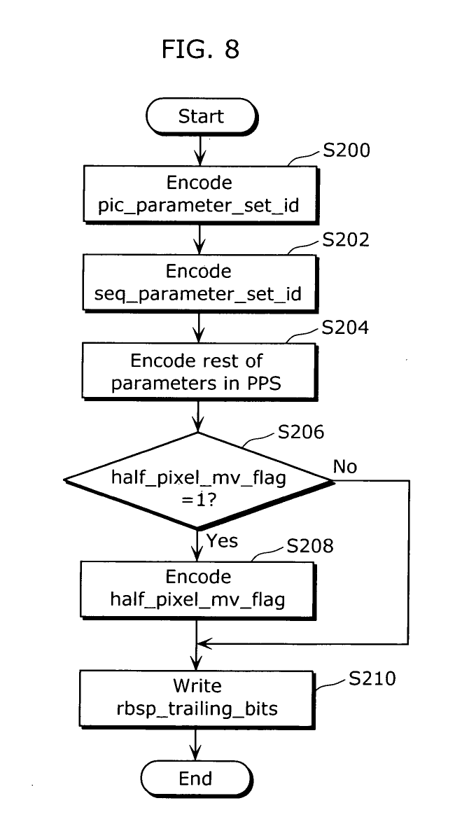

FIG. 8 is a flowchart showing encoding process for the picture parameter set performed by the variable length encoding unit 204 in the picture coding apparatus 200.

First the variable length encoding unit 204 encodes the pic_parameter_set_id in the picture parameter set (step S200). Next the variable length encoding unit 204 encodes the seq_parameter_set_id in the picture parameter set (step S202). Further the variable length encoding unit 204 encodes the rest of the parameters in the picture parameter set (PPS) (step S204). In fact, the variable length encoding unit 204 encodes, from the first line sequentially, the rest of the prepositional parameters in a plurality of parameters in the picture parameter set other than the half_pixel_mv_flag in the step S200 to step S204.

Here the variable length encoding unit 204 judges whether or not the half_pixel_mv_flag is 1 (step S206). In the case where the half_pixel_mv_flag is 1 (Yes in step S206), the variable length encoding unit 204 encodes the half_pixel_mv_flag, that is “1”, and places the encoded half_pixel_mv_flag immediately after the prepositional parameter which has been encoded lastly (step S208). And the variable length encoding unit 204 writes the rbsp_trailing_bits immediately after the encoded half_pixel_mv_flag (step S210). On the other hand in the case where the half_pixel_mv_flag is 0 (No in step S206), the variable length encoding unit 204 writes the rbsp_trailing_bits immediately after the constrained_intra_pred_flag in the picture parameter set without encoding the half_pixel_mv_flag (step S210). In fact, in the case where the half_pixel_mv_flag is 0, a picture parameter set not including the half_pixel_mv_flag is generated.

Thus the variable length encoding unit 204 of the present embodiment is configured as a picture information encoding apparatus which includes: an encoding unit to encode the half_pixel_mv_flag, which indicates the pixel precision, as one of a plurality of parameters, based on the pixel precision of the motion vector used for encoding the picture; and a placing unit to place the encoded half_pixel_mv_flag at the end of the encoded plurality of parameters.

Accordingly the picture encoding apparatus 200 of the present embodiment is able to generate a picture parameter set, with a data structure having the half_pixel_mv_flag indicating the pixel precision of the motion vector used for decoding pictures, as the last parameter among a plurality of parameters in the picture parameter set.

It should be noted that, in the present embodiment, in the case where the half_pixel_mv_flag is 0, the half_pixel_mv_flag is not encoded. However the half_pixel_mv_flag may be encoded and be placed in the picture parameter set.

The picture information decoding method and the picture information encoding method are described using the embodiment hereinbefore. However the present invention is not limited to the embodiment.

For example the repeated_header_cnt, which is the information representing the number of times that the same picture header has been iterated, may be included in the respective picture headers included repeatedly in the bit stream.

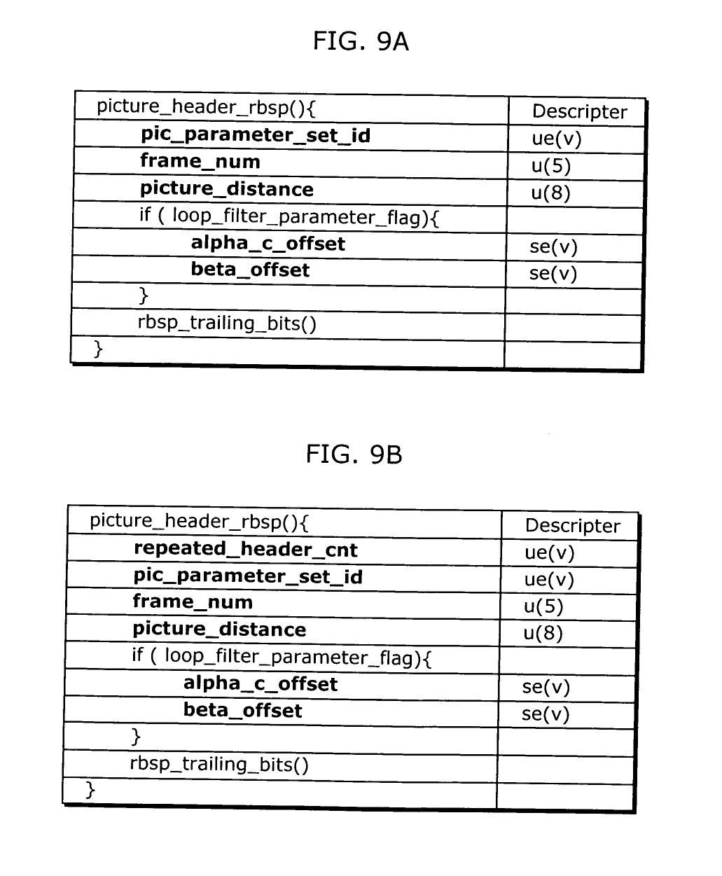

FIG. 9A is a drawing showing a syntax of a conventional picture header.

The picture header as NAL unit includes different parameters for the respective pictures. For example the picture header includes parameters such as the pic_parameter_set_id and the frame_num as shown in FIG. 9A.

In the case where the picture header exists, the NAL unit subsequent to the picture header should be an encoded slice NAL unit. Because the picture header includes important information required for decoding the encoded slice, and an indicator, showing that which picture header belongs to which encoded slice, does not exist in the picture header.

Additionally such picture header includes essential and important information for decoding the encoded slice, so that any errors occurred in the picture header cause errors in decoding process of the entire slices of the pictures.

Such picture header, therefore, is inserted iteratively in the same picture, so as to reduce error occurrences.

However it is not possible to identify the first picture header situated at the beginning of the encoded pictures and the iterated picture headers, so that the picture header cannot be used as identification information indicating the start of a new picture.

In view of the fact, in the present invention, the repeated_header_cnt, which represents the number of times that the same picture header has been iterated, is included in each picture header to be inserted iteratively, so as to use as the picture header to indicate the start of a new picture.

FIG. 9B is a drawing showing a syntax of a picture header including the repeated_header_cnt of the present invention.

As shown in FIG. 9B, the picture header of the present invention includes the repeated_header_cnt, which represents the number of times that the same picture header has been iterated. Here the picture header with the repeated_header_cnt=0 indicates the start of a new picture. After the picture header, the repeated_header_cnt, for the picture header to be iterated sequentially, is incremented by one every iteration. And also in the case where the picture header with the repeated_header_cnt=0 is lost or is damaged, the picture header with, for example, the repeated_header_cnt=1 indicates the start of a new picture.

Accordingly the first picture header situated at the beginning of the encoded pictures and the iterated picture headers can be identified, and the first (not iterated) picture header can be used to indicate the start of a new picture. And also the repeated_header_cnt can be used as a mechanism to search for a boundary between pictures fast.

It should be noted that the specifically iterated picture header may be inserted in the middle of the picture (between slices). For example the picture decoding apparatus is able to skip decoding of pictures, which are partially decodable, and to decode the subsequent picture instead.

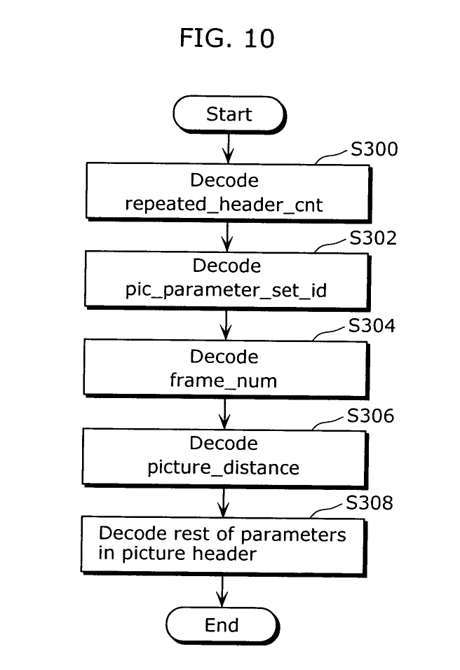

FIG. 10 is a flowchart showing decoding process for the picture header performed by a variable length decoding unit in the picture decoding apparatus.

First the variable length decoding unit decodes the repeated_header_cnt (step S300).

Next the variable length decoding unit decodes the pic_parameter_set_id (step S302). The pic_parameter_set_id represents the picture parameter set that is used for the current encoded picture. And subsequently the variable length decoding unit decodes the frame_num (step S304). The frame_num represents the counter for reference frames.

And then the variable length decoding unit decodes the picture_distance (step S306). The picture_distance represents the counter for the frames in display order.

Lastly the variable length decoding unit decodes the rest of the parameters in the picture header (step S308).

It should be noted that in the case where the variable length decoding unit decodes without fault at least one picture header out of a plurality of picture headers in the same picture, it is not needed to decode the rest of picture headers.

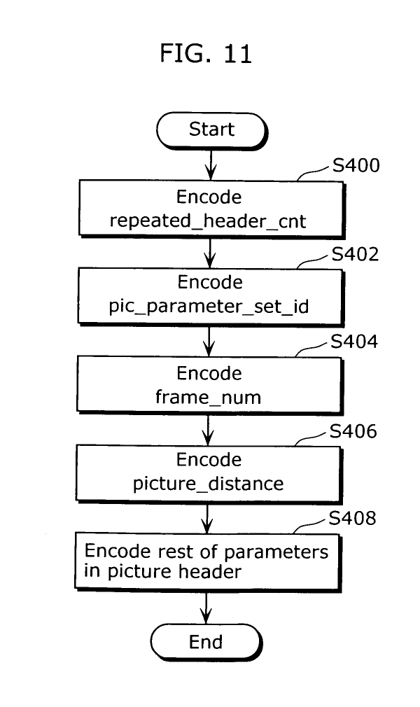

FIG. 11 is a flowchart showing encoding process for the picture header performed by the variable length encoding unit in the picture encoding apparatus.

First the variable length encoding unit encodes the repeated_header_cnt (step S400).

Next the variable length encoding unit encodes the pic_parameter_set_id (step S402). The pic_parameter_set_id represents the picture parameter set that is used for the current encoded picture. And subsequently the variable length encoding unit encodes the frame_num (step S404). The frame_num represents the counter for reference frames.

And then the variable length encoding unit encodes the picture_distance (step S406). The picture_distance represents the counter for the frames in display order.

Lastly the variable length encoding unit encodes the rest of the parameters in the picture header (step S408).

It should be noted that the functionality of each block in the block diagram can be implemented typically in large-scale integrated circuit (LSI). Each functional block can be a chip, or can be one chip including a part of or all of the functional blocks. (For example the functional blocks other than memory can be included in one chip.)

Here LSI is exemplified, but the LSI is called as IC, system LSI, super LSI and ultra LSI depending on the degree of integration.

In addition, the manner of integration of circuit is not limited to LSI, but a dedicated circuit or a general purpose processor can be used for the implementation. After manufacturing LSI, a programmable Field Programmable Gate Array (FPGA), and a reconfigurable processor which can reconfigure a connection and a setup of a circuit cell in LSI may be used.

Furthermore an advent of an integration circuit technology, which can replace the conventional LSI, facilitated by the progress of the semiconductor technology and a derived technology may be obviously used for implementing the integration of the functional blocks. The application to the biotechnology and the like can be conceivable.

In addition, in the functional blocks, the unit to store the data for encoding and decoding may be an individual component, not included in one chip.

Although only exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

What is claimed is:

1. A picture information decoding method for decoding a picture parameter set which includes a plurality of parameters used for decoding a picture, said method comprising:
judging whether or not precision information, which indicates a pixel precision of a motion vector used for decoding the picture, is included as a last parameter among the plurality of parameters in the picture parameter set; and
decoding the precision information in the case where it is judged that the precision information is included as the last parameter in the picture parameter set.

2. The picture information decoding method according to claim 1,
wherein the precision information has a flag which indicates one of 0 and 1, and the precision information indicates quarter-pixel precision in the case where the flag indicates 0.

3. The picture information decoding method according to claim 2,
wherein the precision information indicates half-pixel precision in the case where the flag indicates 1.

4. The picture information decoding method according to claim 1, further comprising:
performing motion compensation using the motion vector with the pixel precision indicated in the decoded precision information, in the case where the precision information is included in the picture parameter set; and
performing motion compensation using the motion vector with a predetermined pixel precision, in the case where the precision information is not included in the picture parameter set.

5. The picture information decoding method according to claim 1
wherein said judging, comprises:
decoding sequentially prepositional parameters which is included in the plurality of parameters excluding the precision information;
judging that the precision information is not included in the case where a predetermined bit string, which is placed at the end of the picture parameter set, is detected immediately after the prepositional parameter which has been decoded lastly; and
judging that the precision information is included in the case where the bit string is not detected immediately after the prepositional parameter which has been decoded lastly.

6. A picture information encoding method for encoding a picture parameter set which includes a plurality of parameters used for a picture, said method comprising:
encoding precision information, which indicates a pixel precision, as one of the plurality of parameters, based on the pixel precision of a motion vector used for encoding the picture; and
placing the encoded precision information at the end of the encoded plurality of parameters.

7. The picture information encoding method according to claim 6,
wherein the precision information has a flag which indicates one of 0 and 1, and the precision information indicates quarter-pixel precision in the case where the flag indicates 0.

8. The picture information encoding method according to claim 7,
wherein the precision information indicates half-pixel precision in the case where the flag indicates 1.

9. The picture information encoding method according to claim 6,
wherein said encoding the precision information comprises:
judging whether or not the pixel precision of the motion vector is a predetermined pixel precision; and
encoding the precision information in the case where the pixel precision of the motion vector is the predetermined pixel precision.

10. The picture information encoding method according to claim 6, further comprising:
encoding sequentially prepositional parameters which is included in the plurality of parameters excluding the precision information;
placing the encoded precision information immediately after the prepositional parameter which has been encoded lastly; and
writing a predetermined bit string immediately after the encoded precision information.

11. A picture information decoding apparatus which decodes a picture parameter set including a plurality of parameters used for decoding a picture, said apparatus comprising:
a judging unit operable to judge whether or not precision information, which indicates a pixel precision of a motion vector used for decoding the picture, is included as a last parameter among the plurality of parameters in the picture parameter set, and
a decoding unit operable to decode the precision information in the case where the precision information is included in the picture parameter set.

12. A picture information encoding apparatus which encodes a picture parameter set including a plurality of parameters used for decoding a picture, said apparatus comprising:
an encoding unit operable to encode precision information, which indicates a pixel precision, included as one of the plurality of parameters, based on the pixel precision of a motion vector used for encoding the picture; and
a placing unit operable to place the encoded precision information at the end of the encoded plurality of parameters.

13. A data structure of a picture parameter set which has a plurality of parameters used for decoding a picture, comprising
precision information included as a last parameter among the plurality of parameters in the picture parameter set, the precision information indicating a pixel precision of a motion vector used for decoding the picture.

14. An integrated circuit in which a picture information decoding method according to claim 1 is implemented.

15. An integrated circuit in which a picture information encoding method according to claim 6 is implemented.
